(19) United States
(12) Patent Application Publication
(10) Pub. No.: US 2026/0175773 A1
(43) Pub. Date: Jun. 25, 2026

(54) TURN SIGNAL SYSTEM FOR A VEHICLE

(71) Applicant: Honda Motor Co., Ltd., Tokyo (JP)

(72) Inventor: Joel C. Zeller, Marysville, OH (US)

(21) Appl. No.: 18/989,571

(22) Filed: Dec. 20, 2024

(51) Int. Cl. B60Q 1/34; B60Q 1/40

(52) U.S. Cl. CPC B60Q 1/343; B60Q 1/40

(57) ABSTRACT

A turn signal system for a vehicle includes a plurality of turn signal lights including at least one left turn signal light and at least one right turn signal light. The turn signal system also includes a controller communicatively coupled with the plurality of turn signal lights and configured to determine an activation of the at least one left turn signal light or the at least one right turn signal light to indicate a lane change of the vehicle. The controller is also configured to control the at least one left turn signal light or the at least one right turn signal light to make a number of blinks before deactivation. The number of blinks is determined based on a drive mode of the vehicle.

### BACKGROUND

The disclosed subject matter relates generally to a vehicle. More particularly, the disclosed subject matter relates to a turn signal system for a vehicle.

Indicator lighting, commonly referred to as turn signals, are well known. Recently, with the incorporation of autonomous driving features in the vehicles, turn signal logic has been changing to support auto lane changing features. However, current turn signal systems lack customization and may therefore fail to accurately indicates the inititation and completion of a lane change.

### SUMMARY

In accordance with one embodiment of the present disclosure, a turn signal system for a vehicle is provided. The vehicle is adapted to be operated in a plurality of drive modes. The turn signal system comprises a plurality of turn signal lights including at least one left turn signal light and at least one right turn signal light. The turn signal system also includes a controller communicatively coupled to the plurality of turn signal lights and configured to determine an activation of the at least one left turn signal light or the at least one right turn signal light to indicate a lane change of the vehicle. Further, the controller is configured to control the at least one left turn signal light or the at least one right turn signal light to make a number of blinks before deactivation. The number of blinks is determined based on a drive mode of the vehicle.

In accordance with another embodiment of the present disclosure, a vehicle is provided. The vehicle is adapted to be operated in a plurality of drive modes and comprises a plurality of turn signal lights including at least one left turn signal light and at least one right turn signal light. The vehicle also includes a controller communicatively coupled with the plurality of turn signal lights and configured to determine an activation of the at least one left turn signal light or the at least one right turn signal light to indicate a lane change of the vehicle. The controller is further configured to control the at least one left turn signal light or the at least one right turn signal light to make a number of blinks before deactivation. The number of blinks is determined based on a drive mode of the vehicle.

In accordance with yet a further embodiment of the present disclosure a method for controlling a turn signal of a vehicle is provided. The vehicle is configured to be operated in a plurality of drive modes and includes a plurality of turn signal lights including at least one left turn signal light and at least one right turn signal light. The method comprises determining, by a controller, an activation of the at least one left turn signal light or the at least one right turn signal light to indicate a lane change of the vehicle. The method further includes controlling, by the controller, the at least one left turn signal light or the at least one right turn signal light to make a number of blinks before deactivation. The number of blinks is determined based on a drive mode of the vehicle.

### BRIEF DESCRIPTION OF THE DRAWINGS

Certain embodiments of the present disclosure will be better understood from the following description taken in conjunction with the accompanying drawings in which:

FIG. 1 is a side perspective view of a vehicle, in accordance with one embodiment of the present disclosure; and

FIG. 2 is a block diagram of the vehicle of FIG. 1 and schematically depicting various components of the vehicle, in accordance with one embodiment of the present disclosure.

### DETAILED DESCRIPTION OF EXEMPLARY EMBODIMENTS

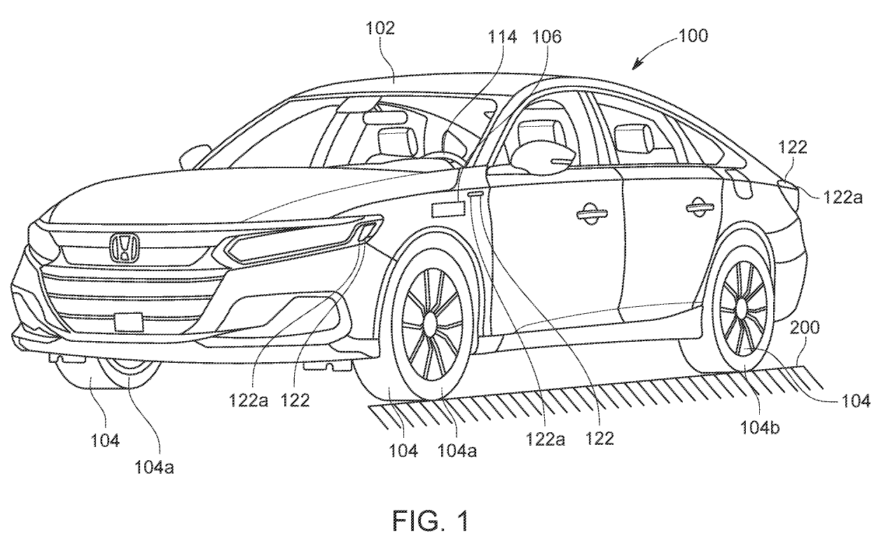

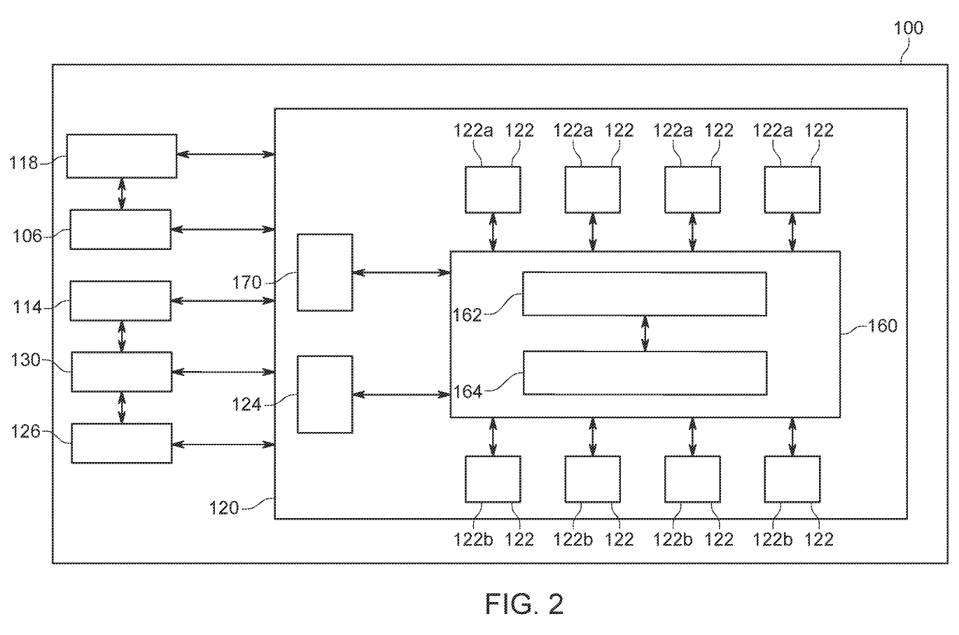

A few inventive aspects of the disclosed embodiments are explained in detail below with reference to the various figures. Exemplary embodiments are described to illustrate the disclosed subject matter, not to limit its scope, which is defined by the claims. Those of ordinary skill in the art will recognize a number of equivalent variations of the various features provided in the description that follows. Embodiments are hereinafter described in detail in connection with the views and examples of FIGS. 1-2, wherein like numbers indicate the same or corresponding elements throughout the views.

FIG. 1 illustrates a side perspective view of a vehicle, indicated generally at 100, in accordance with one embodiment of the present disclosure. The vehicle 100 is shown as a sedan. However, vehicle 100 in accordance with alternative embodiments can comprise any variety of vehicles, including trucks, vans, recreational vehicles, utility vehicles, agricultural equipment, or construction equipment, truck-trailer combination, and/or any other type of vehicle that includes turn signals. The vehicle 100 includes a vehicle body 102 to which various components of the vehicle 100 are mounted, and a plurality of traction members 104, for example, wheels 104, movably supporting the vehicle body 102 on a ground surface 200.

Further, the vehicle 100 includes a power source 106, for example, an internal combustion engine, an electric motor and at least one battery, and/or any other propulsion system for a vehicle providing power to propel the vehicle 100 over the road/surface and auxiliary systems of the vehicle 100. Moreover, the vehicle 100 may include a plurality of driver input devices to facilitate a driver to control the movement of the vehicle 100 along with other operations of the vehicle 100. The controlled operations can include speed control, braking, steering, drive mode control, and the like. The driver input devices may include an accelerator pedal for controlling a speed of the vehicle, a clutch lever, one or more gear shift levers, a steering wheel to control a direction of the travel of the vehicle, and a drive mode selector 118 (shown in FIG. 2), and the like.

The drive mode selector 118 enables a selection of one of a plurality of drive modes in which the vehicle 100 may be operated. In an embodiment, the plurality of drive modes may include a sport mode and at least one non-sport mode. More specifically, non-sport modes may include, but are not limited to, an economy mode, a normal mode, a sand mode, a dirt mode, a snow mode, and a trail mode. Furthermore, in at least some embodiments, the non-sport modes may include a trailer towing mode. It may be appreciated that each of the drive modes includes separate operating characteristics, for example, speed vs torque curve, to enable a desired performance of the vehicle 100 in the selected drive mode. For example, upon selection of the economy mode, the power source 106 and/or a drivetrain of the vehicle 100 is operated/controlled to provide maximum efficiency i.e., the vehicle 100 provides increased gas mileage from an internal combustion engine or an increased driving range from an electric motor/battery drivetrain. Similarly, in the sport mode, the power source 106 and/or the drivetrain is controlled so as to provide higher acceleration. And furthermore, in the trailer towing mode the operating characteristics are designed to optimize the ability of the vehicle 100 to tow a trailer.

Further, the vehicle 100 includes a steering wheel 114 operatively coupled to the wheels 104 to rotate/turn the front wheels 104a and/or rear wheels 104b to enable/control the turning of the vehicle 100 in left and right direction. Further, referring to FIG. 2, to indicate to pedestrians and/or other drivers in vehicles near vehicle 100 a turning direction of the vehicle 100, and to control such indication, the vehicle 100 includes a turn signal system 120. The turn signal system 120 includes a plurality of turn signal lights 122 configured to flash or blink in a manner known to indicate an upcoming change in direction. The plurality of turn signal lights 122 may include, for example, at least one left turn signal light 122a and at least one right turn signal light 122b, mounted to the vehicle body 102. In an embodiment, the at least one left turn signal light 122a is attached to a left side of the vehicle body 102, while the at least one right turn signal light 122b is attached to a right side of the vehicle body 102. Further, to actuate the turn signal lights 122a, 122b to indicate the turning direction of the vehicle 100, the turn signal system 120 may include a turn signal actuator 124 arranged in communication with an indicator switch 126 adapted to be operated/actuated by a driver of the vehicle 100. In an embodiment, the indicator switch 126 is arranged to be displaced manually by a driver to a first position to actuate the at least one left turn signal light 122a and to a second position to actuate the at least one right turn signal light 122b to indicate the turning direction of the vehicle 100.

In some embodiments, the vehicle 100 may include an automatic system 130 that determines initiation of the lane change/turn or an impending lane change/turning based on one or more parameters related to driving of the vehicle 100. In an embodiment, the one or more driving parameters includes a traffic condition, a location and the route of travel of the vehicle 100, an upcoming turn for the vehicle 100 based on the route of the vehicle 100, a detection of upcoming lane closure, a speed restricted zone, a rotation of the steering wheel 114, or any other such travel parameter of the vehicle 100. In some embodiments, the automatic system 130 may be arranged in communication with at least one sensor, for example, a camera, a lidar, a radar, etc., a lane change control system, an autonomous driving system, an autonomous driving system, or any combination thereof, and determines the initiation of the lane change/turn or an impending lane change/turning based on the input received from such systems. In such a case, the turn signal actuator 124 is arranged in communication with the automatic system 130 to actuate/activate either the left turn signal lights 122a or the right turn signal lights 122b.

It may be appreciated that each of the left turn signal light 122a and the right turn signal light 122b is adapted to make a number of blinks upon actuation and is adapted to be switched off upon completion of the number of blinks by the turn signal lights 122. For so doing, the turn signal system 120 includes a controller 160 communicatively coupled to the turn signal actuator 124, the right turn signal lights 122b and the left turn signal lights 122a to control the actuation of the left turn signal lights 122a or the right turn signal lights 122b to blink the left turn signal light 122a or the right turn signal light 122b. In some embodiments, the controller 160 is also arranged in communication with the manual indicator switch 126 and/or the automatic system 130 to determine the activation of the turn signal i.e., the left turn signal lights 122a or the right turn signal lights 122b.

In some embodiments, the controller 160 may be an electronic control module (ECM) of the vehicle 100. The controller 160 includes a processor 162 and a memory 164 to respectively process and store the data received from one or more of the turn signal actuators 124, the drive mode selector 118, the automatic system 130, the indicator switch 126, the power source 106, and any other electrical and electronic component of the vehicle 100. In some embodiments, the instructions to process the data received from the turn signal actuator 124, the drive mode selector 118, the automatic system 130, the indicator switch 126, the power source 106, the number of blinks corresponding to each drive mode, one or more driver’s driving profile and associated skill levels are stored inside the memory 164 of the controller 160.

The memory 164 may be integrated into the controller 160, but those skilled in the art will understand that the memory 164 may be separate from the controller 160 but onboard the vehicle 100, and/or remote from the controller 160 and the vehicle 100, while still being associated with and accessible by the controller 160 to store information in and retrieve information from the memory 164 as necessary during the operation of the vehicle 100 i.e., turn signal system 120. Although the processor 162 is contemplated, it is also possible and contemplated to use other electronic components such as a microcontroller, an application specific integrated circuit (ASIC) chip, or any other integrated circuit device. The processor 162 is configured to execute specified instructions, which controls and monitors various functions associated with power source 106, the turn signal system 120, the automatic system 130, the indicator switch 126, turn signal actuator 124, and its components, etc.

Upon determination of initiation of turning or lane change of the vehicle or impending turning or lane change of the vehicle 100, i.e., the activation of the left turn signal lights 122a or the right signal lights 122b, the controller 160 is configured to control the left turn signal lights 122a or the right turn signal lights 122b to make a number of blinks and deactivate the turn signal lights upon making the number of blinks. In the embodiment, the processor 162 determines the number of blinks based on a drive mode of the vehicle 100 in which the vehicle 100 is currently operating, controls the left turn signal lights 122a or the right signal lights 122 accordingly to make the determined number of blinks. It should be appreciated that the number of blinks for each drive mode will vary from each other. For example, a number of blinks associated with the sport mode is lower than a number of blinks associated with a non-sport mode. Furthermore, each type of non-sport mode may apply a different number of blinks. For example, the turn signal may be deactivated after a greater number of blinks when the vehicle 100 is in towing mode than when the vehicle 100 is in a normal mode. In at least some embodiments, the number of blinks is predetermined based on the length of time typically used to complete a lane change and/or other turn. For example, if vehicle 100 is towing a trailer (e.g., driver selects a towing mode), the driver will typically use more time to complete a lane change than if vehicle 100 was not towing a trailer. Accordingly, the turn signal will be activated for a longer length of time (i.e., greater number of blinks) when in towing mode than when in normal mode. In another example embodiment, when a driver has selected sport mode, the driver may typically use less time to complete a lane change than when the driver has selected a non-sport mode. Accordingly, the turn signal will be activated for a shorter length of time (i.e., lower number of blinks) when in sport mode than when in a non-sport mode. It may be appreciated that the data related to a number of blinks associated with each drive mode is stored inside the memory 164. Also, it may be envisioned that the number of blinks associated with each drive mode, in some optional or additional embodiments, may be adaptively changed/determined, by the processor 162, based on the driver’s past driving behavior, for example, historical data associated with a time taken by the driver to complete a turn/lane change in the drive mode, and/or a skill level of the driver.

In some embodiments, the processor 162 may keep monitoring the vehicle 100 during the lane changing/turning of the vehicle 100 to determine the completion of the lane change/turn, and determines whether the lane change/turn is completed relatively early before the deactivation of the turn signal lights 122 or the turn signal lights 122 are deactivated before the lane/change/turn is completed. Accordingly, the processor 162 updates the number of blinks for the driver associated with the drive mode based on such observations/determinations. Therefore, the number of blinks associated with a driver and/or a drive mode may change over time, and accordingly the controller 160 i.e., processor 162 may adaptively change a number of blinks of the turn signal lights 122 associated with one or more drive modes for a specific driver. In these embodiments, the vehicle 100 identifies the current driver and applies stored information associated with that driver.

In some embodiments, the turn signal system 120 may include an input device 170 configured to receive a user selection corresponding to a selected driving skill level of the driver. The input device 170 may be included within an existing user interface or input device of vehicle 100, for example, an infotainment system touch screen, or any other input device that allows turn signal system 150 to function as described herein. The driving skill level may be determined based on a driver’s driving profile stored inside the memory 164. It may be appreciated that the processor 162 may assign/determine a relatively high number of blinks for a novice driver and a relatively low number of blinks for a skilled driver. It may be envisioned that, in some embodiments, the driver’s driving profile is updated based on one or more driving characteristics/parameters of the driver determined and stored as the driver drives the vehicle 100. Accordingly, the driving skill level may change over time, and accordingly, the controller 160 i.e., processor 162 may adaptively change the number of blinks for the driver.

In embodiments where the processor 162 monitors the vehicle 100 during the lane changing/turning of the vehicle 100 and determines a recommended number of blinks for the driver associated with the drive mode based on such observations/determinations, the processor 162 may automatically adjust the number of blinks applied to future activation of the turn signal lights 122. In an alternative embodiment, the processor 162 may cause a display device, for example a center display and/or another display included within an instrument panel of the vehicle 100, to display the recommended number of blinks and/or an explanation as to why the processor 162 is recommending a change to the current number of blinks, along with a message that allows the driver to accept or reject the change to the current number of blinks. For example, the message may appear on the center display and/or another display included within the instrument panel of vehicle 100 when the vehicle 100 is stopped/turned off. In other examples, the message may appear in a smartphone application (i.e., an app associated with vehicle 100), the smartphone app allows the user to select accept or reject (e.g., yes or no) the change to the number of blinks and transmits that selection to the vehicle 100.

Also, the processor 162 may assign a relatively large/high number of blinks associated with one or more drive modes when the speed during turning/lane change is relatively low and assigns a relatively small/low number of blinks when the speed of change/turning is relatively high. In an embodiment, it may be envisioned that processor 162 may determine the number of blinks adaptively based on the drive mode of the vehicle 100 and one or more of the driver’s historical data, driver’s skill level, and a speed of the vehicle 100. In this manner, the turn signal system 120 facilitates the correct indication of the lane change or turning of the vehicle to the following vehicle depending upon the vehicle’s driving characteristics as well as driver’s driving behavior.

The foregoing description of embodiments and examples has been presented for purposes of illustration and description. It is not intended to be exhaustive or to limit the disclosure to the forms described. Numerous modifications are possible in light of the above teachings. Some of those modifications have been discussed and others will be understood by those skilled in the art. The embodiments were chosen and described in order to best illustrate certain principles and various embodiments as are suited to the particular use contemplated. The scope of the disclosure is, of course, not limited to the examples or embodiments set forth herein, but can be employed in any number of applications and equivalent devices by those of ordinary skill in the art. Rather it is hereby intended that the scope of the disclosure be defined by the claims appended hereto.

What is claimed is:

1. A turn signal system for a vehicle adapted to be operated in a plurality of drive modes, the turn signal system comprising:
a plurality of turn signal lights including at least one left turn signal light and at least one right turn signal light; and
a controller communicatively coupled to the plurality of turn signal lights and configured to
determine an activation of the at least one left turn signal light or the at least one right turn signal light to indicate a lane change of the vehicle, and
control the at least one left turn signal light or the at least one right turn signal light to make a number of blinks before deactivation, wherein the number of blinks is determined based on a drive mode of the vehicle.

2. The turn signal system of claim 1, wherein the controller is further configured to determine the number of blinks for the drive mode based on a driver’s driving profile.

3. The turn signal system of claim 2, wherein the controller is configured to determine the number of blinks for the drive mode based on a historical data associated with a time taken by the driver to the complete the lane change.

4. The turn signal system of claim 1, wherein the controller determines the number of blinks based on a speed of the vehicle during the lane change.

5. The turn signal system of claim 4, wherein the controller is configured to control the at least one left turn signal light or the at least one right turn signal light to make a lower number of blinks before deactivation when the speed of the vehicle is higher than when a speed of the vehicle is lower.

6. The turn signal system of claim 1, wherein the turn signal system further comprises an indicator switch adapted to be displaced by the driver of the vehicle, and wherein the controller is configured to determine the activation of the at least one left turn signal light or the at least one right turn signal light based on an input received from the indicator switch.

7. The turn signal system of claim 1, wherein the plurality of drive modes comprises a towing mode and at least one non-towing mode, and wherein the controller is configured to control the at least one left turn signal light or the at least one right turn signal light to make a higher number of blinks before deactivation when in the towing mode than when in the non-towing mode.

8. The turn signal system of claim 1, wherein the plurality of drive modes comprises a sport mode and at least one non-sport mode, and wherein the controller is configured to control the at least one left turn signal light or the at least one right turn signal light to make a lower number of blinks before deactivation when in the sport mode than when in the non-sport mode.

9. A vehicle adapted to be operated in a plurality of drive modes, the vehicle comprising:
a plurality of turn signal lights including at least one left turn signal light and at least one right turn signal light;
a controller communicatively coupled with the plurality of turn signal lights and configured to
determine an activation of the at least one left turn signal light or the at least one right turn signal light to indicate a lane change of the vehicle, and
control the at least one left turn signal light or the at least one right turn signal light to make a number of blinks before automatic deactivation, wherein the number of blinks is determined based on a drive mode of the vehicle.

10. The vehicle of claim 9 further comprising a drive mode selector to enable a selection of one of the plurality of drive modes, and the controller is communicatively coupled to the drive mode selector to determine the drive mode of the vehicle.

11. The turn signal system of claim 9, wherein the controller is further configured to determine the number of blinks for the drive mode based on a driver’s driving profile.

12. The vehicle of claim 7, wherein the controller determines the number of blinks based on a speed of the vehicle during the lane change.

13. The vehicle of claim 12, wherein the controller is configured to control the at least one left turn signal light or the at least one right turn signal light to make a lower number of blinks before deactivation when the speed of the vehicle is higher than when a speed of the vehicle is lower.

14. The vehicle of claim 9 further comprises an automatic system configured to determine the initiation of the lane change and the controller is configured to determine the activation of the at least one left turn signal light or the at least one right turn signal light based on input received from the automatic system.

15. The vehicle of claim 9, wherein the plurality of drive modes comprises a towing mode and at least one non-towing mode, and wherein the controller is configured to control the at least one left turn signal light or the at least one right turn signal light to make a higher number of blinks before deactivation when in the towing mode than when in the non-towing mode.

16. The vehicle of claim 9, wherein the plurality of drive modes comprises a sport mode and at least one non-sport mode, and wherein the controller is configured to control the at least one left turn signal light or the at least one right turn signal light to make a lower number of blinks before deactivation when in the sport mode than when in the non-sport mode.

17. A method for controlling a turn signal of a vehicle configured to be operated in a plurality of drive modes, the vehicle includes a plurality of turn signal lights including at least one left turn signal light and at least one right turn signal light, the method comprising:
determining, by a controller, an activation of the at least one left turn signal light or the at least one right turn signal light to indicate a lane change of the vehicle, and
controlling, by the controller, the at least one left turn signal light or the at least one right turn signal light to make a number of blinks before deactivation, wherein the number of blinks is determined based on a drive mode of the vehicle.

18. The method of claim 16, wherein the controller determines the number of blinks based on a speed of the vehicle during the lane change, wherein the controller is configured to control the at least one left turn signal light or the at least one right turn signal light to make a smaller number of blinks before deactivation when the speed of the vehicle is higher than when a speed of the vehicle is lower.

19. The method of claim 16, wherein the plurality of drive modes comprises a towing mode and at least one non-towing mode, and wherein the controller is configured to control the at least one left turn signal light or the at least one right turn signal light to make a higher number of blinks before deactivation when in the towing mode than when in the non-towing mode.

20. The method of claim 16, wherein the plurality of drive modes comprises a sport mode and at least one non-sport mode, and wherein the controller is configured to control the at least one left turn signal light or the at least one right turn signal light to make a lower number of blinks before deactivation when in the sport mode than when in the non-sport mode.
